(19) United States
(12) Patent Application Publication
(10) Pub. No.: US 2017/0278029 A1
(43) Pub. Date: Sep. 28, 2017

(54) MANAGEMENT DEVICE AND METHOD THEREOF

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventor: Ying TAO, Shenzhen (CN)

(21) Appl. No.: 15/141,837

(22) Filed: Apr. 29, 2016

(30) Foreign Application Priority Data
Mar. 28, 2016 (CN) 201610178178.4

(51) Int. Cl. G06Q 10/06

(52) U.S. Cl. CPC G06Q 10/0633; G06Q 10/063112

(57) ABSTRACT

A management device includes an environment module, a status module, and a solution module. The environment module is used to determine whether one or more of the factors relevant to a working environment meet a first condition. The status module is used to determine whether a working status is normal. The solution module is used to provide solutions corresponding to various operating or non-operating states. A management method is also provided.

### FIELD

The present disclosure relates to employee management and a method thereof.

### BACKGROUND

Skill training and machine maintenance are very important for production efficiency. Solution for problems occurring in a process of manufacturing is also important for production efficiency.

Therefore, there is room for improvement in the art.

### BRIEF DESCRIPTION OF THE DRAWING

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of a management device of the present disclosure.

FIG. 2 is a flow chart of an embodiment of a management method of the present disclosure.

FIG. 3 is also a flow chart of an embodiment of the management method of the present disclosure.

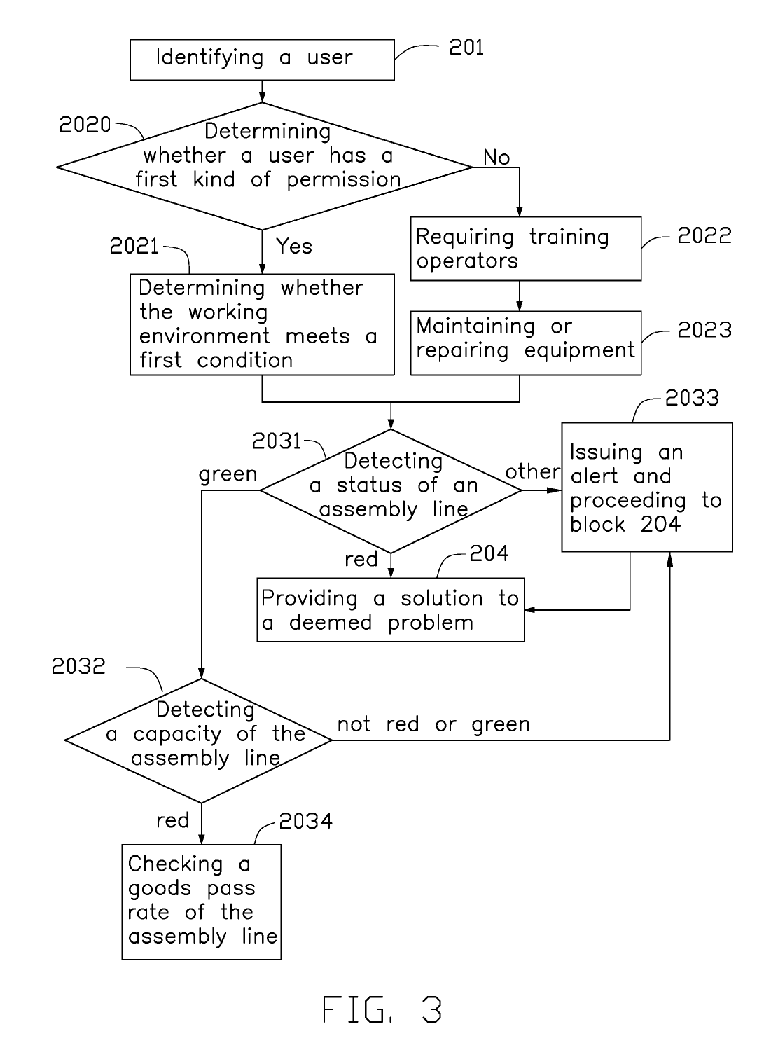

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like. The term “operate normally” means “operate without problems”.

References to “an” or “one” embodiment in this disclosure are not necessarily to the same embodiment, and such references mean “at least one.” The reference “a plurality of” means “at least two.”

The disclosure will now be described in relation to a management device 100.

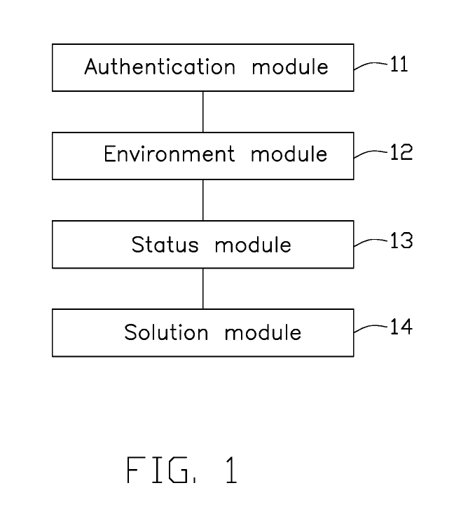

FIG. 1 shows an embodiment of the management device 100 of the present disclosure.

The management device 100 can comprise an authentication module 11, an environment module 12, a status module 13, and a solution module 14.

The management device 100 can be used in a manufacturing process.

In one embodiment, the management device 100 is used in an assembly line.

The authentication module 11 can be configured to provide a login window and confirm or deny the identity of a user. Fingerprint identification or iris recognition can be used in a process to confirm the identity of the user.

In one embodiment, different kinds of accounts are provided by the authentication module 11. A first kind of account has an advanced permission, such as a permission to skip or ignore a working environment. A second kind of account may require confirmation or otherwise as to a working environment meets a first condition.

In one embodiment, when a user having the second kind of account has logged in, the authentication module 11 outputs a first signal to the environment module 12 to command the environment module 12 to confirm whether the working environment meets the first condition.

The environment module 12 is electrically coupled to the authentication module 11. The environment module 12 is configured to detect a working environment and to determine whether the working environment meets the first condition.

The working environment can comprise but is not limited to respective statuses regarding various items of equipment and skills of operators, and conditions applying thereto.

Statuses of equipment can be defined to comprise different kinds. A first kind of status can be defined as good. A second kind of status can be defined as acceptable. A third kind of status can be defined as bad.

In one embodiment, the equipment may function as the transporter of goods. When a speed of the transport is lower than a first speed, the status of the equipment is deemed bad. When the speed of the transport is between the first speed and a second speed, the status of the equipment is deemed acceptable. When the speed of the transmission is higher than the second speed, the status of the equipment is deemed good.

When the status of the equipment is deemed to be bad, the equipment may need maintainance or repair.

Skills of operators can be defined to comprise different kinds. A first kind of skill level can be defined as good. A second kind of skill level can be defined as acceptable. A third kind of skill level can be defined as bad.

In one embodiment, when an operator cannot finish working on a single product within a first time period the skill level of the operator is deemed bad. When the skill level of the operator is deemed bad, the operator can need training to improve the skill level.

In other embodiments, the statuses of equipment can also comprise a goods pass rate.

In one embodiment, the first condition indicates that the status of the equipment is good and the skill level of operators is good. When the working environment can meet the first condition, the environment module 21 outputs a second signal to the status module 13, to activate the status module 13.

The status module 13 is configured to detect a capacity and a status of the assembly line.

When the status of the assembly line is deemed not good, the assembly line is deemed to be not operating normally and the status module 13 outputs to the solution module 14 a third signal, which requests a cause of failure. The solution module 14 provides a solution accordingly.

When the status of the assembly line is deemed good, the status module 13 detects the capacity of the assembly line. When the capacity of the assembly line is greater than a preset value, the management device 100 continues monitoring the status of the assembly line and the assembly line is deemed to be operating normally. When the capacity of the assembly line is smaller than the preset value, the management device checks each station on the assembly line to determine a cause.

In one embodiment, the management device 100 comprises an indicating unit and an alert unit. When the status of the assembly line is deemed good, the indicating unit shows green. When the status of the assembly line is deemed bad, the indicating unit shows red. When the indicating unit does not show not red or green, the alert unit issues an alarm to indicate that the assembly line must be checked. The indicating unit and the alert unit can be controlled by the status module 13.

In one embodiment, the solution module 14 can comprise a database. The database stores a plurality of different solutions for different problems.

The management device 100 can be a multimedia system. The multimedia system can comprise at least one computer, at least one logic chip, at least one monitor, at least one camera, and a data storage device. The authentication module 11 can comprise a computer. The environment module 12 can comprise at least one monitor and a logic chip. The status module 13 can comprise at least one camera and a logic chip. The solution module 14 can comprise a logic chip and storage device.

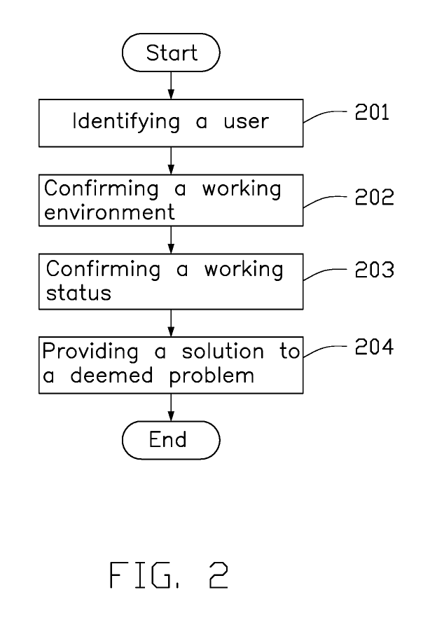

FIG. 2 illustrates a flowchart of a management method. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized without departing from this disclosure. The example method can begin at block 200.

At block 201, identifying a user;

At block 202, confirming a working environment;

At block 203, confirming a working status;

At block 204, providing a solution to a deemed problem.

Block 202 can comprise:

Block 2020, determining whether a user has a first kind of permission;

Block 2021, determining whether the working environment meets a first condition when a user has a first kind of permission only.

Block 2022, requiring training operators when the user has a certain skill level and a second kind of permission;

Block 2023, maintaining or repairing equipment when the user has a second kind of permission.

Block 203 can comprise:

Block 2031, detecting a status of an assembly line. When the status of the assembly line is deemed good, the method proceeds to block 2032. When the status of the assembly line is deemed bad, the method proceeds to block 2033. When the status of the assembly line cannot be identified or determined, the method proceeds to block 2033.

Block 2032, detecting a capacity of the assembly line. When the capacity of the assembly line is bad, the method proceeds to block 2034. When the capacity of the assembly line cannot be identified or determined, the method proceeds to block 2033.

Block 2033, issuing an alert and proceeding to block 204.

Block 2034, checking a goods pass rate of the assembly line and proceeding to block 204.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A management device, comprising:
an environment module to determine whether an environment of working meets a first condition;
a status module comprising at least one camera to determine whether a status of operating is normally; and
a solution module to provide solutions corresponding to status of operating.

2. The management device of claim 1, further comprising an authentication module for identification of a user.

3. The management device of claim 1, wherein the environment of working comprises skill of operators.

4. A management method for a management device, comprising:
identifying a user;
confirming an environment of working;
confirming a status of working;
providing a solution.

5. The management method of claim 4, further comprising:
determining whether the environment of working meet a first condition when the user has a first kind of permission.

6. The management method of claim 4, further comprising:
training skill of operators when the user has a second kind of permission.

7. The management method of claim 4, further comprising:
maintaining equipments when the user has a second kind of permission.

8. The management method of claim 4, further comprising:
detecting a status of an assembly line.

9. The management method of claim 4, further comprising:
detecting a capacity of the assembly line.
